(19) United States
(12) Patent Application Publication
(10) Pub. No.: US 2012/0024106 A1
(43) Pub. Date: Feb. 2, 2012

(54) CONTINUOUS CASTING GEARBOX COMPRISING HEAT SHIELDING

(75) Inventor: Herbert Brotzki, Duisburg (DE)

(73) Assignee: SMS SIEMAG AKTIENGESELLSCHAFT, Dusseldorf (DE)

(21) Appl. No.: 13/260,687

(22) PCT Filed: Mar. 26, 2010
(86) PCT No.: PCT/EP10/01936

§ 371 Date: Sep. 27, 2011

(30) Foreign Application Priority Data
Mar. 27, 2009 (DE) 10 2009 015 380.2

(51) Int. Cl. F16H 57/04

(52) U.S. Cl. 74/606 A

(57) ABSTRACT

The invention comprises a continuous casting gearbox (1, 10, 100) used for operating rolls or rollers in a continuous casting plant. The gearbox (1, 10, 100) has water-bearing chambers (2, 20, 200) for shielding against heat radiation and hot convection. Due to the fact that the continuous casting gearbox (1, 10, 100) is surrounded by the chambers (2, 20, 200), it is possible to achieve an effective shielding, thus being able to avoid gearbox damage caused by an gearbox oil overheat.

### FIELD OF THE INVENTION

The invention relates to a continuous casting gearbox which is used for driving rollers or rolls in roll stands of a continuous casting plant. The housing of the gearbox has a heat shield.

### STATE OF THE ART

In the state of the art of gearboxes, cooling devices are provided whose primary purpose is to limit the gearbox temperatures, which are due to the mechanical friction within the gearbox and would rise to too high a level without suitable cooling. Accordingly, as a rule, oil is contained within a gearbox, wherein the oil is cooled, for example, by air through an appropriately shaped gearbox housing via cooling ribs.

In the special case of continuous casting plants, increased requirements are made of the cooling of the gearbox: Due to the casting operation which sometimes takes place uninterrupted for days, the continuous casting gearboxes are subjected to very high temperatures of up to 1,000° C. over a very long period of time. If a continuous casting gearbox operates within a multiple-strand continuous casting operation, there is additionally a very strong heat radiation from the hot adjacent strands.

A conventional method for gearbox cooling is the use of circulating oil lubrications with oil backcooling. This system has the disadvantage that initially the entire heat must be absorbed by the gearbox in order to be then transmitted to the oil and to be removed through oil heat exchangers. Because of the extreme conditions of continuous casting operations, such a method is not suitable for solely cooling a continuous casting gearbox.

Generally possible are also measures in which, in the area of the oil reservoir of the gearbox, elements with water or an additional oil cooling are provided.

Such an example is shown in DE 60 2005 002 651, wherein in an industrial drive unit, cooling elements which cool the oil reservoir are arranged below the recommended oil level of the housing of the drive unit. In addition, it may also be provided that cooling elements are arranged in the area of the housing which during operation of the industrial drive unit is sprayed with oil. However, such a system, which in principle is supposed to cool the oil reservoir of the gearbox, cannot ensure a comprehensive and sufficient heat shield of the continuous casting gearbox during casting operation.

EP 0853 225 A2 shows a gearbox which has an opening into which is placed a heat exchanger plate in the form of a cover. This cover is filled with cooling agent and has an inlet and an outlet and is profiled. However, such an arrangement has the disadvantage that it cannot serve for shielding against external heat influence. The profiling even further increases the heat transmission to the gearbox interior. Preferably, even guide plates extending into the gearbox interior are provided which would even further increase such a disadvantageous heat transmission. In addition, the cover cannot serve for shielding the entire gearbox because the cover only covers a small portion of the gearbox.

The device of WO 2007/124885 A2, in which a cooling module for a gearbox is described, has similar disadvantages with respect to heat shielding. Also in this case, the cooling module is placed in an opening of the gearbox which has inwardly and outwardly directed cooling ribs and has cooling agent flowing through it.

Patent Specification DE 36 06 963 C2 discloses a machine housing casing which is constructed as an oil cooler. This casing is intended for gearboxes having a cubic structural shape and is provided with radial webs and ribs. The webs and ribs serve for the best possible heat transmission between the gearbox and the surroundings of the gearbox. Such a system or a similar system cannot serve for shielding a continuous casting gearbox.

The printed document DE 31 50 659 A1 discloses a continuous casting gearbox with a housing and at least one water-conducting chamber which immediately surrounds the housing, so that the continuous casting gearbox is shielded against external heat influences. The water conducting chamber has at least one water inlet and water outlet.

Starting from this state of the art, it is the object of the invention to make available for a known continuous casting gearbox a more effective shielding device for cooling the continuous casting gearbox, wherein the shielding device is to be reusable for gearboxes of the same construction.

This object is met by the subject matter of claim 1. The latter is characterized in that the continuous casting gearbox comprises cooling plates which are arranged at the outer side of the gearbox housing and sealed relative to the outer wall, and wherein the water-conducting chamber is formed by the space between the cooling plates and the outer side of the gearbox housing, and that the cooling plates are removable and/or have maintenance openings.

Consequently, a continuous casting gearbox comprises a housing, wherein the gearbox housing is immediately surrounded by water-conducting chambers which have at least one water inlet and at least one water outlet, in order to shield the gearbox against outer heat influences.

A continuous casting gearbox which is immediately surrounded by water-conducting chambers can advantageously significantly better withstand outer heat influences.

In accordance with claim 1, the chambers are formed by a space between the outer side of the gearbox housing and cooling plates in front thereof. Cooling plates represent the side wall of the chamber located opposite the outer side of the gearbox, and are sealed relative to the outer side of the gearbox housing with the exception of the water inlet and the water outlet. The arrangement of cooling plates on the outer side of the gearbox has the effect that water can flow directly between the outer wall of the gearbox and the cooling plate wall. Such cooling plates can also be subsequently provided in already existing gearboxes.

Since the cooling plates are removable, they can be reused for gearboxes of the same construction. In addition, they can be disassembled for maintenance purposes, for which purpose, depending on the type of application, a maintenance opening or flap can also serve.

In accordance with a second preferred embodiment, the chambers are constructed as hollow spaces in gearbox housings (having multiple walls).

In accordance with a further preferred embodiment of the continuous casting gearbox, the chambers are arranged on all sides of the gearbox. As a result of the fact that the chambers are arranged on all sides of the gearbox, a very effective heat shield is realized for the entire gearbox.

In another preferred embodiment of the continuous casting gearbox, the gearbox comprises at least one heat shield plate which is arranged on one of the sides of the gearbox, wherein the plate is connected to the water-conducting chambers for cooling. By the arrangement of an optional heat shield plate, the cooling effect can be further improved because such a heat shield plate can prevent thermal radiation as well as convection. The heat of the plate can be conducted away directly through a connection to the water-conducting chambers.

In a further preferred embodiment of the continuous casting gearbox, the at least one heat shield plate is connected through spacer bolts to the water-conducting chambers, so that the heat of the heat shield plate can be conducted away to the water-conducting chambers through the spacer bolts.

In another preferred embodiment of the continuous casting gearbox, the gearbox comprises a driven shaft and a heat shield plate which is arranged on the side of the driven shaft of the gearbox and through which the driven shaft extends through a bore.

In accordance with another preferred embodiment of the continuous casting gearbox, the gearbox comprises a cover arranged on the side of the gearbox located opposite the driven shaft and connected directly to the water-conducting chambers so that seals and bearings arranged in this area are protected against heat. The cover is recommended especially in multiple-strand casting plants in which also on the side located opposite the driven shaft there may still extend a parallel strand which radiates significant heat in the direction toward the gearbox.

In accordance with another preferred embodiment of the continuous casting gearbox, the gearbox comprises internal and/or external bypass ducts which are arranged between the water inlet and the water outlet, so that an automatic ventilation of the water-conducting chambers can take place.

Such bypass ducts ensure that no air inclusions can be formed in the cooling system. Also, the air which penetrates into the system during the first start-up can escape.

In accordance with another preferred embodiment of the continuous casting gearbox, the bypass ducts are arranged at a highest location of the chambers and/or are formed by an external line which conducts air into the water outlet.

In accordance with another preferred embodiment of the continuous casting gearbox, the water-conducting chambers each have a water inlet and a water outlet, or are connected to each other and have a common water inlet and water outlet.

In another preferred embodiment of the continuous casting gearbox, the water is conducted in the water conducting chambers from the water inlet to the water outlet through ducts.

In accordance with another preferred embodiment of the continuous casting gearbox, the ducts are arranged in such a way that the water is conducted in the chambers from the water inlet to the water outlet in a meandering configuration.

By conducting the water in ducts, or especially in meandering ducts, a uniform cooling of the gearbox is facilitated.

In accordance with another preferred embodiment of the continuous casting gearbox, the cooling plates comprise webs which are arranged at the cooling plates in the direction of the gearbox housing and are formed by the ducts between the cooling plates and the gearbox housing.

In accordance with another preferred embodiment of the continuous casting gearbox, the gearbox comprises a driven shaft seal, wherein in front of the driven shaft seal, which seals the driven shaft relative to the outer side of the gearbox housing, at the outer side of the gearbox housing at least one further driven shaft seal is arranged, so that the latter can serve as a part which can be sacrificed.

Shaft seals are relatively sensitive and become brittle due to the heat influence and finally untight. To ensure that the seal does not become untight, which in the worst case can lead to gearbox damage, a second seal is arranged toward the other side as a part which can be sacrificed in front of the actual seal.

### SHORT DESCRIPTION OF THE FIGURES

In the following, the figures of the embodiments are described briefly. Additional details can be taken from the detailed description of the embodiments. In the drawing:

FIG. 1a shows a schematic side view of an embodiment of the continuous casting gearbox according to the invention on which water-conducting chambers and heat shield plates are mounted;

FIG. 1b shows a schematic side view of the continuous casting gearbox shown in FIG. 1a with a view of the opposite side of the gearbox;

FIG. 1c is a schematic top view of the embodiment according to the invention of a continuous casting gearbox according to FIGS. 1a and 1b;

FIG. 2a is a schematic cross sectional view of another embodiment of a continuous casting gearbox according to the invention which is surrounded by water-conducting chambers;

FIG. 2b is a schematic side view of the continuous casting gearbox of FIG. 2a;

FIG. 2c is a schematic cross sectional view of a continuous casting gearbox according to FIG. 2a, wherein the broken lines illustrate the water outlet and ventilation;

FIG. 3 is a perspective view of two continuous casting gearbox halves with water-conducting chambers;

FIG. 4a shows possible mounting positions of a continuous casting gearbox according to FIGS. 1a to 1c;

FIG. 4b shows possible mounting positions of a continuous casting gearbox according to FIGS. 2a to 2c;

FIG. 5a shows a side view and a top view of the output side of a bevel gear continuous casting gearbox in connection with a motor;

FIG. 5b shows two side views of a helical bevel gear continuous casting gearbox according to the invention.

### DETAILED DESCRIPTION OF THE EMBODIMENTS

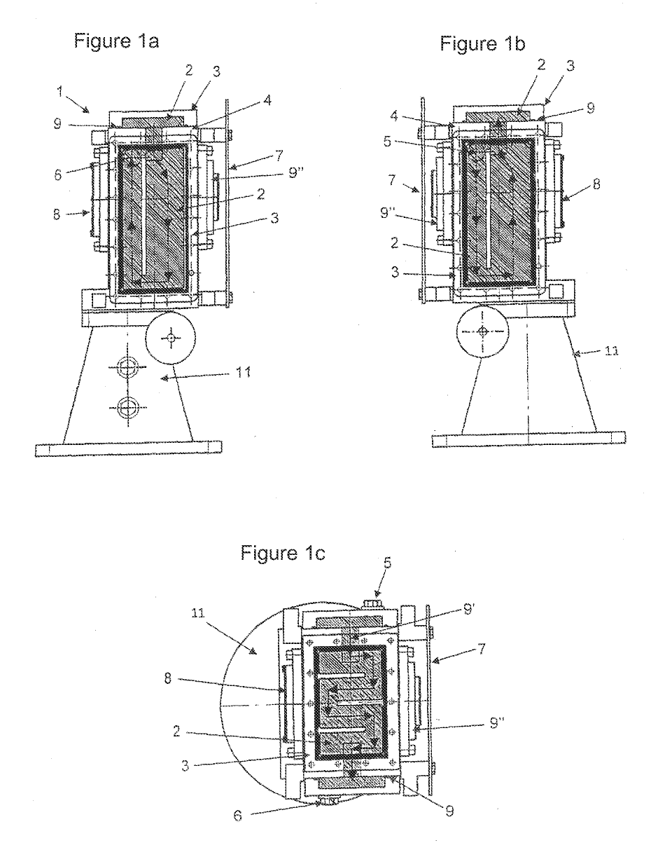

FIG. 1a shows a continuous casting gearbox 1, particularly a helical bevel gearbox which can be connected on its input side to a motor through a flange 11. The gearbox 1 is composed in this embodiment of two gearbox halves which are sealed in the assembled state by a seal 9′ (see FIG. 1c). The gearbox according to the invention is thereby surrounded by cooling water chambers 2. On the output side, the gearbox is connected through a shaft to a roller or a roll (not shown). This shaft (driven shaft) extends through an opening in the heat shield plate 7 which is arranged on the output side (driven side) of the gearbox 1. On the oppositely located side a cover plate 8 is also arranged which, in the same manner as the cooling chambers 2 and the heat shield plate 7 on the driven side, serves for heat shielding. In this connection, the plates 7, 8 are connected to the cooling chambers 2, so that the heat of the plates 7, 8 can be conducted away directly through the cooling water. In the embodiment, water is conducted through the chambers 2 which are placed directly in the form of a plate 3 and sealed by seals 9 on the housing of the continuous casting gearbox 1. The chambers 2 are arranged at the walls of the gearbox 1. The chambers 2 are preferably connected to each other through passages, so that the cooling water, which flows through a water inlet 5 into a first chamber 2, reaches the chamber 2 on the upper side of the gearbox and is connected through another passage to the lateral cooling plate 2 (FIG. 1a) and the water is once again conducted away by means of the water outlet 6. The water cycle can be either closed or also open. In the chambers 2 the water can be forcibly conducted, as shown by the arrows in the illustrations 1a through 1c. As a result of this forced conduction it can be ensured that no hot cooling water can collect at certain locations in a chamber 2. The forced conduction is ensured by ducts and by appropriately arranged webs which form the ducts. As shown in the figures, the ducts extend, for example, so as to meander. However, the configuration of the ducts can also be constructed differently, so that a uniform cooling can be ensured. The webs are preferably located on the plates 3 which are placed on the gearbox housing 4. In the embodiment of FIGS. 1a to 1c, the plates 3 are preferably removable and are screwed, for example, by means of screws to the gearbox housing 4 and sealed by means of the seals 9. Since the plates 3 are removable, a maintenance of the cooling device or of gearbox components can be carried out without disassembling the gearbox 1. If desired, the plates 3 can also be welded onto the housing 4.

It is generally also possible to provide appropriately configured cooling chambers 2 on all sides of the housing 4, so that, if desired, they completely surround the gearbox 1, wherein openings are merely provided for the input and the output of the drive shafts and the driven shafts. Moreover, in the embodiment according to the invention, a second seal 9″ is provided for the driven shaft, wherein the second seal serves as a seal which can be sacrificed in front of the actual seal. Accordingly, this seal is arranged in front of the conventional shaft seal, i.e., toward the outside in the direction of the heat influence.

it is further possible that heat shield plates, like the plates 7 and 8, are arranged on additional sides of the gearbox 1 or completely surround the gearbox 1. The shield plates can be connected through spacer bolts to the gearbox housing 4 or the water-conducting chambers 2, as shown for the heat shield plate 7 in the illustrations of FIGS. 1a-1c, or also in a different manner fixedly or releasably connected to the gearbox housing 4 or to the water-conducting chambers 2.

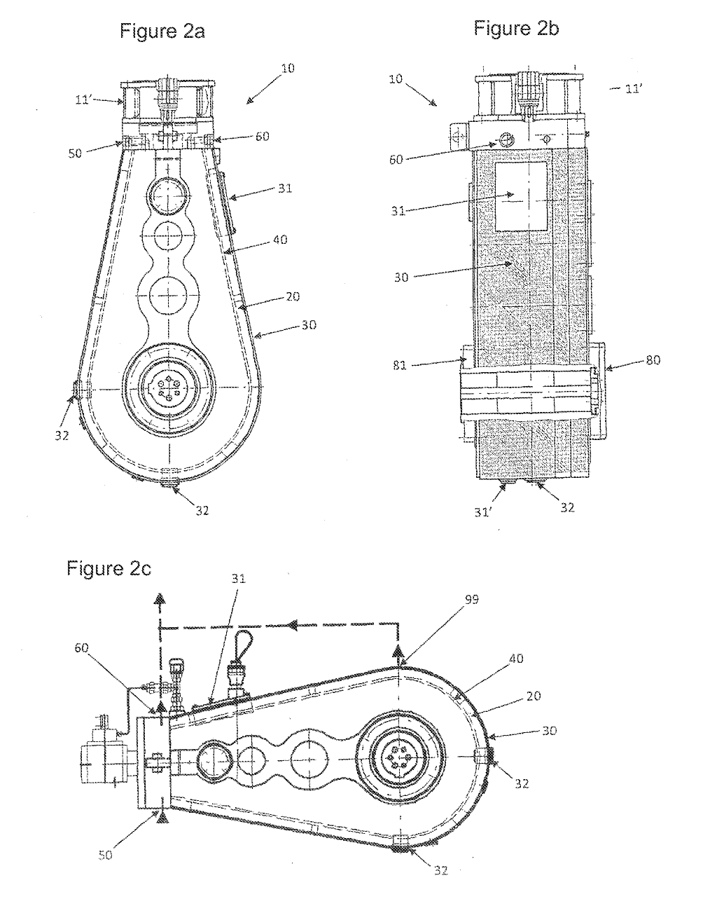

FIG. 2 shows another embodiment 10 according to the invention of a helical bevel gearbox for the continuous casting operation. The gearbox housing 40 is surrounded by water-conducting chambers 20. The plates 30 are preferably welded to the gearbox housing, but can also be removably connected or screwed to the housing 40. The chambers 20 have an inlet 50 as well as an outlet 60 and preferably inspection openings 31, 31′. Such inspection openings significantly facilitate the maintenance of the gearbox 10 and of the cooling device. The heater-conducting chambers 20 enclose or surround the gearbox 10. Only the side on which the flange 11′ for the connection to a motor is located (drive side) is not provided with a water-conducting chamber 20. However, in accordance with the invention, it is also possible to provide water-conducting chambers 20 at this location and merely have the drive shaft extend between motor and gearbox 10 through an opening in such a chamber 20.

Moreover, an opening for a driven shaft (not shown) is provided which is surrounded by an additional seal 81 which can be sacrificed (similar to the embodiment according to FIGS. 1a-1c), and a sheet metal plate or cover plate 80 which protects the oppositely located side of the driven side of the gearbox against heat. Furthermore, the chambers 20 can be provided with water discharge devices 32 in order to completely empty the water in the chambers 20 of the gearbox 10, for example, prior to beginning a storage where there is the danger of frost.

FIG. 2c illustrates especially the possibility of a ventilation of the continuous casting gearbox 10 according to the invention, wherein the location of the gearbox which is at the highest level in the drawing is provided with a ventilation opening 99 at which preferably air collects. In accordance with the embodiment, this air can be conducted away through the water line which leads away from the water 60 (see broken line). Moreover, ventilations by means of bypass ducts are conceivable which may also be provided internally in the housing 40 or in the plates 30 in the form of bores or other external bypasses. In order to possibly circumvent a ventilation or to provide fewer ventilation lines, the water-conducting chambers 20 can also be constructed especially so as to be favorable to flow, so that no air or only very little air can collect in the chambers 20.

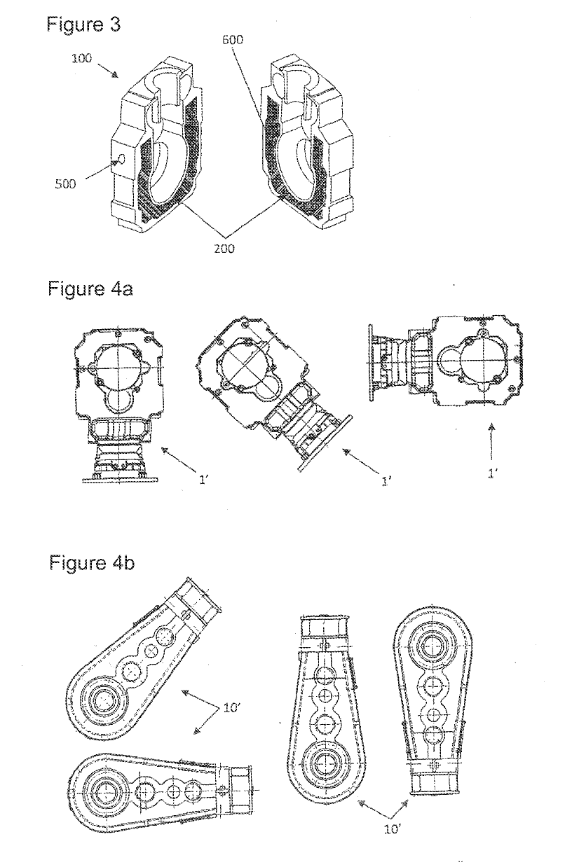

FIG. 3 shows another embodiment of a continuous casting gearbox 100 according to the invention, wherein the continuous casting gearbox 100 is surrounded by water-conducting chambers 200. This embodiment is a cast construction. In this embodiment, the water flows through the water inlet 500 into the water-conducting chambers and is conducted out of the chambers once again through the water outlet 600.

The above-mentioned features of all embodiments can generally be combined with each other and are not limited to one of the embodiments.

FIG. 4a shows for completeness various typical mounted positions of continuous casting gearboxes 1′, in a row in vertical mounted position, in an inclined mounted position or in a horizontal mounted position. The illustrated gearboxes 1′ have essentially the same basic configuration of the gearbox 1. In FIG. 4b, various mounted positions of a gearbox 10′ are shown analogous to a gearbox 10. The various illustrated mounted positions demonstrate that the gearboxes 10 can be operated in various manners, so that, for example, in the area located at the highest location of the water-conducting chambers, a ventilation must be mounted.

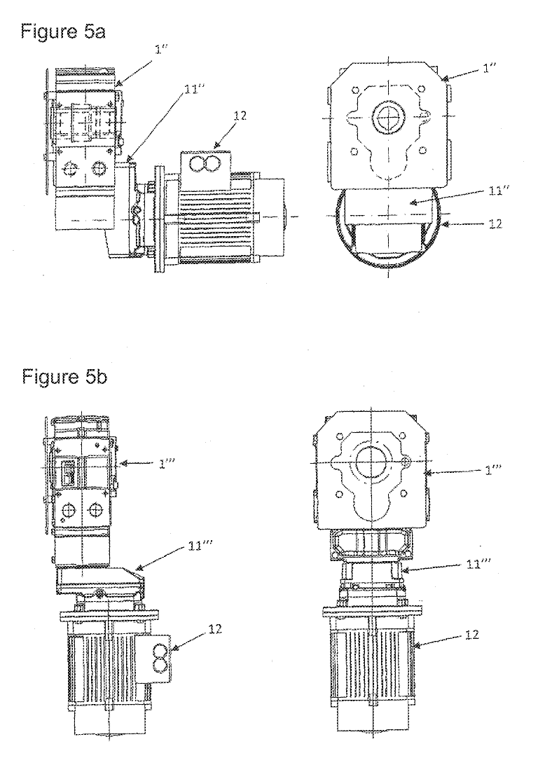

FIG. 5a shows a gearbox 1″, similar to the gearbox 1, which is connected through a flange 11″ with a motor 12. However, the gearbox shown in FIG. 5a is a bevel gearbox.

Finally, FIG. 5b schematically shows a helical bevel gearbox 1′″, analogous to the continuous casting gearbox 1, wherein the gearbox 1′″ is connected through a flange 11′″ to a motor 12.

### LIST OF REFERENCE NUMERALS

1 Continuous casting gearbox
1′ Continuous casting gearbox
1″ Continuous casting gearbox
1′″ Continuous casting gearbox
2 Water-conducting chamber
3 Plate
4 Gearbox housing
5 Water inlet
6 Water outlet
7 Heat shield plate
8 Cover
9 Chamber seal
9′ Housing seals
9″ Shaft seal
10 Continuous casting gearbox
10′ Continuous casting gearbox
11 Flange
11′ Flange
11″ Flange
11′″ Flange
12 Motor
20 Water-conducting chamber
30 Plate
31 Maintenance opening
31′ Maintenance opening
32 Water discharge
40 Gearbox housing
50 Water inlet
60 Water outlet
80 Cover
81 Shaft seal
99 Ventilation
100 Continuous casting gearbox
200 Chamber
500 Water inlet
600 Water outlet

1-14. (canceled)

15. A continuous casting gearbox, comprising:
a housing;
at least one water-conducting chamber that immediately surrounds the gearbox housing so that the gearbox is shielded against outer heat influences, the water-conducting chamber having at least one water inlet and at least one water outlet; and
cooling plates arranged at an outer side of the gearbox housing and sealed relative to the outer wall of the housing, the water-conducting chamber being formed by a space between the cooling plates and the outer side of the gearbox housing, the cooling plates being removable and/or having maintenance openings.

16. The continuous casting gearbox according to claim 15, wherein the water-conducting chamber is a hollow space in the gearbox housing.

17. The continuous casting gearbox according to claim 15, wherein water-conducting chambers are provided on all sides of the gearbox housing.

18. The continuous casting gearbox according to claim 15, further comprising at least one heat shield plate mounted on one side of the gearbox housing, the plate being thermally conductively connected to the water-conducting chamber for cooling.

19. The continuous casting gearbox according to claim 18, further comprising spacer bolts that connect the at least one heat shield plate to the water-conducting chamber so that heat of the heat shield plate is conducted away through the spacer bolts to the water-conducting chamber.

20. The continuous casting gearbox according to claim 18, further comprising a driven shaft on one side of the gearbox, the heat shield plate being arranged on the side of the gearbox with the driven shaft, the driven shaft being guided through a bore in the heat shield plate.

21. The continuous casting gearbox according to claim 20, further comprising a cover arranged on a side of the gearbox located opposite the driven shaft, the cover being directly connected to the water-conducting chamber so that seals and bearings arranged at that location are protected against heat.

22. The continuous casting gearbox according to claim 15, further comprising internal and/or external bypass ducts arranged between the water inlet and the water outlet.

23. The continuous casting gearbox according to claim 22, wherein the bypass ducts are arranged at a highest location of the chamber and/or are formed by an external line which conducts air into the water outlet.

24. The continuous casting gearbox according to claim 15, comprising a plurality of water conducting chambers, the water-conducting chambers each having a water inlet and a water outlet.

25. The continuous casting gearbox according to claim 15, comprising a plurality of water conducting chambers, the water-conducting chambers connected to each other and having a common water inlet and a common water outlet.

26. The continuous casting gearbox according to claim 15, wherein water in the water-conducting chamber is conducted from the water inlet through ducts to the water outlet.

27. The continuous casting gearbox according to claim 26, wherein the ducts are arranged so that the water in the water-conducting chamber is conducted from the water inlet through the ducts to the water outlet in a meandering configuration.

28. The continuous casting gearbox according to claim 26, wherein webs are arranged on the cooling plates so as to extend in a direction of the gearbox housing, and wherein the ducts between the cooling plates and the gearbox housing are formed by the webs.

29. The continuous casting gearbox according to claim 20, further comprising a driven shaft seal that seals the driven shaft relative to the outer side of the gearbox housing, and at least one additional driven shaft seal, in front of the driven shaft seal, on the outer side of the gearbox housing so that the additional shaft seal is sacrificial.
